(19) United States
(12) Patent Application Publication
(10) Pub. No.: US 2025/0146140 A1
(43) Pub. Date: May 8, 2025

(54) ELECTROCHEMICAL SYSTEM

(71) Applicants: Hyundai Motor Company, Seoul (KR); Kia Corporation, Seoul (KR)

(72) Inventors: Hyo Kyung Han, Seoul (KR); Kwi Seong Jeong, Yongin-si (KR); Won Seok Yang, Yongin-si (KR)

(21) Appl. No.: 18/443,543

(22) Filed: Feb. 16, 2024

(30) Foreign Application Priority Data
Nov. 6, 2023 (KR) 10-2023-0152000

(51) Int. Cl. C25B 1/04; C25B 9/70; C25B 15/033; C25B 15/08

(52) U.S. Cl. CPC C25B 1/04; C25B 9/70; C25B 15/033; C25B 15/083; C25B 15/087

(57) ABSTRACT

An embodiment of an electrochemical system includes a reaction fluid supply line configured to supply a reaction fluid, a first gas-liquid separator connected to the reaction fluid supply line and configured to separate the reaction fluid into a gaseous reaction fluid and a liquid reaction fluid, a circulation line connected to the first gas-liquid separator and configured to allow the liquid reaction fluid to circulate therethrough, a water electrolysis stack provided in the circulation line, and a first bypass line having a first end at an upstream side of the water electrolysis stack and connected to the circulation line, and a second end at a downstream side of the water electrolysis stack and connected to the circulation line.

### CROSS-REFERENCE TO RELATED APPLICATIONS

This application claims the benefit of Korean Patent Application No. 10-2023-0152000, filed on Nov. 6, 2023, which application is hereby incorporated herein by reference.

### TECHNICAL FIELD

The present disclosure relates to an electrochemical system for filtering ions and foreign substances from a reaction fluid.

### BACKGROUND

There is a consistently increasing need for research and development on alternative energy to cope with global warming and depletion of fossil fuel. Hydrogen energy is attracting attention as a practical solution for solving environmental and energy issues.

In particular, because hydrogen has high energy density and properties suitable for application on a grid-scale, hydrogen is in the limelight as a future energy carrier.

A water electrolysis stack, which is an electrochemical apparatus, refers to a device that produces hydrogen and oxygen by electrochemically decomposing water. A water electrolysis stack may be configured by stacking several tens or several hundreds of water electrolysis cells (unit cells) in series.

Meanwhile, when a reaction fluid (reactant) (e.g., water) to be supplied to the electrochemical device (e.g., the water electrolysis stack) contains ions and foreign substances (impurities), the performance, durability, and reliability of the electrochemical device are degraded. Therefore, such degrading may be reduced by removing ions and foreign substances contained in the reaction fluid as much as possible.

### SUMMARY

The present disclosure relates to an electrochemical system, and more particularly, to an electrochemical system capable of ensuring the performance of a water electrolysis stack and improving the durability and stability of the water electrolysis stack.

An embodiment of the present disclosure can provide a filter device for an electrochemical apparatus capable of ensuring the performance of a water electrolysis stack and improving the durability and stability of the water electrolysis stack.

In particular, an embodiment of the present disclosure can allow a low-quality reaction fluid (e.g., a reaction fluid having high ionic conductivity) to flow to a circulation line along a bypass line and be reprocessed (e.g., deionized) without being supplied to the water electrolysis stack.

Among other things, an embodiment of the present disclosure can extend the lifespan of a water electrolysis stack and minimize the deterioration in durability and stability of the water electrolysis stack caused by low-quality reaction fluid being supplied to the water electrolysis stack.

An embodiment of the present disclosure can continuously supply the reaction fluid to the water electrolysis stack without stopping an operation of a system at the time of replacing a filter and prevent the low-quality reaction fluid from being supplied to the water electrolysis stack.

An embodiment of the present disclosure can prevent contaminants, which remain on an inner wall surface of a gas-liquid separator, from being supplied to the water electrolysis stack.

The advantages achieved by embodiments of the present disclosure are not necessarily limited to the above-mentioned advantages, and additional advantages may be understood from the solutions or embodiments described below.

To achieve some or all of the above-mentioned advantages, according to an example embodiment of the present disclosure, an electrochemical system includes a reaction fluid supply line configured to supply a reaction fluid, a first gas-liquid separator connected to the reaction fluid supply line and configured to separate the reaction fluid into a gaseous reaction fluid and a liquid reaction fluid, a circulation line connected to the first gas-liquid separator and configured to allow the liquid reaction fluid to circulate therethrough, a water electrolysis stack provided in the circulation line, and a first bypass line having one end positioned at an upstream side of the water electrolysis stack and connected to the circulation line, and the other end positioned at a downstream side of the water electrolysis stack and connected to the circulation line.

According to an example embodiment of the present disclosure, the electrochemical system may include a first circulation three-way valve provided in the circulation line and connected to one end of the first bypass line.

According to an example embodiment of the present disclosure, the electrochemical system may include a first circulation ion sensor positioned at the upstream side of the water electrolysis stack, provided in the circulation line, and configured to sense ionic conductivity of the liquid reaction fluid, in which the first circulation three-way valve is configured to allow the liquid reaction fluid to selectively flow from the upstream side of the water electrolysis stack to the downstream side of the water electrolysis stack on the basis of a sensing result from the first circulation ion sensor.

According to an example embodiment of the present disclosure, the electrochemical system may include a circulation filter positioned between the first gas-liquid separator and an inlet of the water electrolysis stack, provided in the circulation line, and configured to filter the liquid reaction fluid.

According to an example embodiment of the present disclosure, the electrochemical system may include a filter part provided in the reaction fluid supply line and configured to filter the reaction fluid.

According to an example embodiment of the present disclosure, the filter part may include a first filter line connected to the reaction fluid supply line and equipped with a first filter, and a second filter line positioned in parallel with the first filter line, connected to the reaction fluid supply line, and equipped with a second filter.

According to an example embodiment of the present disclosure, the electrochemical system may include a filter three-way valve provided in the reaction fluid supply line and connected to one end of the first filter line and one end of the second filter line.

According to an example embodiment of the present disclosure, the electrochemical system may include a first filter ion sensor positioned at a downstream side of the first filter, provided in the first filter line, and configured to sense ionic conductivity of the reaction fluid, and a second filter ion sensor positioned at a downstream side of the second filter, provided in the second filter line, and configured to sense ionic conductivity of the reaction fluid, in which the filter three-way valve selectively switches a movement route for the reaction fluid to the first filter line or the second filter line on the basis of sensing results from the first filter ion sensor and the second filter ion sensor.

According to an example embodiment of the present disclosure, the electrochemical system may include a second bypass line positioned at the downstream side of the water electrolysis stack and connected to the circulation line, a second gas-liquid separator connected to the second bypass line and configured to separate the liquid reaction fluid, which flows along the second bypass line, into a gaseous reaction fluid and a liquid reaction fluid, and a recirculation line having one end connected to the second gas-liquid separator, and the other end connected to the first gas-liquid separator, the recirculation line being configured to recirculate the liquid reaction fluid, which has passed through the second gas-liquid separator, to the first gas-liquid separator.

According to an example embodiment of the present disclosure, the electrochemical system may include a second circulation three-way valve provided in the circulation line and connected to one end of the second bypass line.

According to an example embodiment of the present disclosure, the electrochemical system may include a second circulation ion sensor positioned at the downstream side of the water electrolysis stack, provided in the circulation line, and configured to sense ionic conductivity of the liquid reaction fluid, in which the second circulation three-way valve is configured to allow the liquid reaction fluid to selectively flow from the circulation line to the second bypass line on the basis of a sensing result from the second circulation ion sensor.

According to an example embodiment of the present disclosure, the electrochemical system may include a third bypass line having one end connected to the recirculation line, and the other end connected to the second gas-liquid separator.

According to an example embodiment of the present disclosure, the electrochemical system may include a recirculation three-way valve provided in the recirculation line and connected to the third bypass line.

According to an example embodiment of the present disclosure, the electrochemical system may include a recirculation ion sensor provided in the recirculation line and configured to sense ionic conductivity of the liquid reaction fluid, in which the recirculation three-way valve is configured to allow the liquid reaction fluid to selectively flow from the recirculation line to the third bypass line on the basis of a sensing result from the recirculation ion sensor.

According to an example embodiment of the present disclosure, the electrochemical system may include a storage part positioned at an upstream side of the first gas-liquid separator, provided in the reaction fluid supply line, and configured to store the reaction fluid.

According to an example embodiment of the present disclosure, the electrochemical system may include a first cleaning line having one end connected to the storage part, and the other end connected to the second gas-liquid separator, the first cleaning line being configured to supply the reaction fluid to an inner wall surface of the second gas-liquid separator.

According to an example embodiment of the present disclosure, the electrochemical system may include a discharge line connected to the second gas-liquid separator and configured to discharge the liquid reaction fluid to the outside from the second gas-liquid separator, an on-off valve configured to selectively open or close the discharge line, and an ion sensor provided in the second gas-liquid separator and configured to sense ionic conductivity of the liquid reaction fluid in the second gas-liquid separator, in which the on-off valve is configured to selectively open the discharge line on the basis of a sensing result from the ion sensor.

According to an example embodiment of the present disclosure, the electrochemical system may include a second cleaning line having one end connected to the first cleaning line, and the other end connected to the first gas-liquid separator, the second cleaning line being configured to supply the reaction fluid to an inner wall surface of the first gas-liquid separator.

### BRIEF DESCRIPTION OF THE DRAWINGS

The above and other features and advantages of the present disclosure can be more apparent from the following detailed description taken in conjunction with the accompanying drawings of example embodiments, in which:

FIG. 1 is a block diagram of an electrochemical system according to an embodiment of the present disclosure;

FIGS. 2 to 4 are block diagrams for explaining movement routes for a reaction fluid along circulation lines in an electrochemical system according to an embodiment of the present disclosure;

FIGS. 5 and 6 are block diagrams for explaining movement routes for the reaction fluid along filter parts in an electrochemical system according to an embodiment of the present disclosure;

FIGS. 7 and 8 are diagrams for explaining a cleaning line in an electrochemical system according to an embodiment of the present disclosure; and

FIG. 9 is a diagram for explaining a modified example of a second gas-liquid separator of an electrochemical system according to an embodiment of the present disclosure.

### DETAILED DESCRIPTION OF ILLUSTRATIVE EMBODIMENTS

Hereinafter, example embodiments of the present disclosure will be described in detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in describing the embodiments of the present disclosure may be construed as the meaning that may be commonly understood by a person with ordinary skill in the art to which the present disclosure pertains. The meanings of commonly used terms, such as terms defined in dictionaries, may be interpreted in consideration of the contextual meanings of the related technology.

In addition, terms used in the embodiments of the present disclosure are for explaining the embodiments, not necessarily for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as “first,” “second,” “A,” “B,” “(a),” and “(b)” may be used to describe constituent elements of embodiments of the present disclosure. These terms can be used merely for the purpose of discriminating one constituent element from another constituent element, and the nature, the sequences, or the orders of the constituent elements are not necessarily limited by such terms.

Further, when one constituent element is described as being “connected,” “coupled,” or “attached” to another constituent element, one constituent element may be connected, coupled, or attached directly to another constituent element or connected, coupled, or attached to another constituent element through still another constituent element or elements interposed therebetween.

In addition, the expression “one constituent element is provided or positioned above (on) or below (under) another constituent element” includes not only a case in which the two constituent elements are in direct contact with each other, but also a case in which one or more other constituent elements are provided or positioned between the two constituent elements. The expression “above (on) or below (under)” may mean a downward direction as well as an upward direction based on one constituent element.

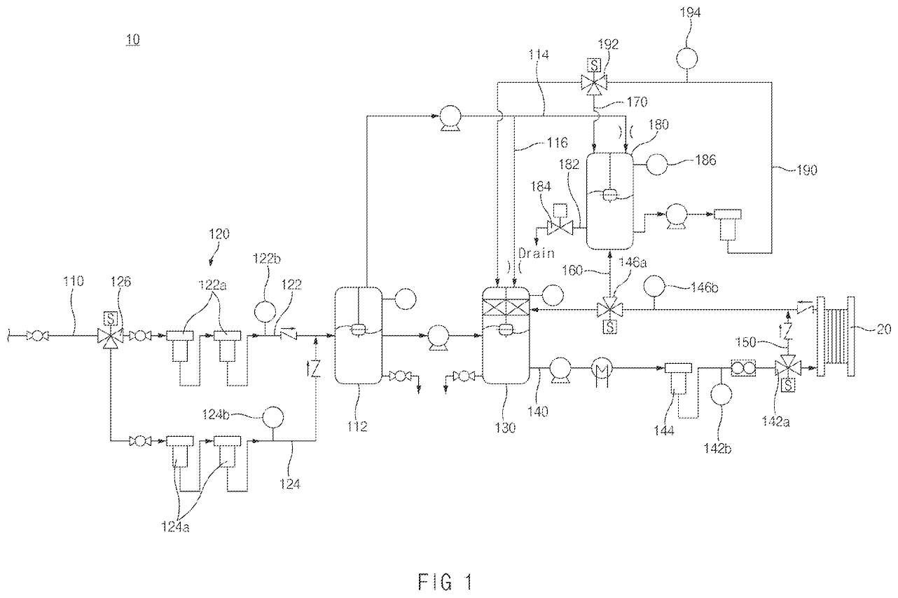

With reference to FIGS. 1 to 9, for an embodiment of the present disclosure an electrochemical system 10 includes a reaction fluid supply line 110 configured to supply a reaction fluid, a first gas-liquid separator 130 connected to the reaction fluid supply line 110 and configured to separate the reaction fluid into a gaseous reaction fluid and a liquid reaction fluid, a circulation line 140 connected to the first gas-liquid separator 130 and configured to allow the liquid reaction fluid to circulate therethrough, a water electrolysis stack 20 provided in the circulation line 140, and a first bypass line 150 having one end positioned at an upstream side of the water electrolysis stack 20 and connected to the circulation line 140, and the other end the first bypass line 150 positioned at a downstream side of the water electrolysis stack 20 and connected to the circulation line 140.

For reference, an electrochemical system 10 according to an embodiment of the present disclosure may be used to generate electrochemical reactions between various reaction fluids in accordance with required conditions and design specifications. The present disclosure is not necessarily restricted or limited by the type and property of the reaction fluid used for the electrochemical system 10.

For example, an electrochemical system 10 according to an embodiment of the present disclosure may be used to produce hydrogen and oxygen by decomposing water (reaction fluid) through an electrochemical reaction.

The reaction fluid supply line 110 can be configured to supply the reaction fluid (e.g., water) to the water electrolysis stack 20.

The reaction fluid supply line 110 may have various structures capable of supplying the reaction fluid. The present disclosure is not necessarily restricted or limited by the structure and shape of the reaction fluid supply line 110.

For example, the reaction fluid supply line 110 may be defined in an approximately straight shape. According to another embodiment of the present disclosure, the reaction fluid supply line may be defined in a curved shape or other shapes.

In addition, the reaction fluid supply line 110 may be equipped with various types of accessory devices, such as a pump (not illustrated) configured to forcibly move the reaction fluid along the reaction fluid supply line 110, and a valve (not illustrated) configured to selectively open or close the reaction fluid supply line 110. The present disclosure is not necessarily restricted or limited by the types of accessory devices and the number of accessory devices.

According to an example embodiment of the present disclosure, the electrochemical system 10 may include a filter part 120 provided in the reaction fluid supply line 110 and configured to filter the reaction fluid.

In an embodiment of the present disclosure, the configuration in which the filter part 120 filters the reaction fluid may be a configuration in which the filter part 120 removes ions and foreign substances (impurities) contained in the reaction fluid.

The filter part 120 may have various structures capable of filtering out ions and foreign substances (impurities) contained in the reaction fluid. The present disclosure is not necessarily restricted or limited by the type and structure of the filter part 120.

According to an example embodiment of the present disclosure, the filter part 120 may include a plurality of filter lines connected in parallel.

Hereinafter, an example will be described in which the filter part 120 includes two filter lines. According to another embodiment of the present disclosure, the filter part may include three or more filter lines. Alternatively, the filter part may include only a single filter line.

According to an example embodiment of the present disclosure, the filter part 120 may include a first filter line 122 connected to the reaction fluid supply line 110 and equipped with first filters 122a, and a second filter line 124 connected in parallel with the first filter line 122, connected to the reaction fluid supply line 110, and equipped with second filters 124a.

For example, a plurality of first filters 122a may be connected (configured) in series in the first filter line 122, and a plurality of second filters 124a may be connected (configured) in series in the second filter line 124.

Various ion filters capable of filtering out ions and foreign substances (impurities) contained in the reaction fluid may be used as the first filter 122a and the second filter 124a. The present disclosure is not necessarily restricted or limited by the type and properties of the ion filter. For example, a prefilter, a carbon filter, a reverse osmosis (RO) membrane filter, an ion exchange resin, an ultraviolet (UV) lamp, the like, or any combination thereof, may be used as the first filter 122a and the second filter 124a.

According to an example embodiment of the present disclosure, the electrochemical system 10 may include a filter three-way valve 126 provided in the reaction fluid supply line 110 and connected to one end of the first filter line 122 and one end of the second filter line 124.

Various three-way valves capable of switching the movement route for the reaction fluid, which is supplied along the reaction fluid supply line 110, to the first filter line 122 or the second filter line 124 may be used as the filter three-way valve 126. The present disclosure is not necessarily restricted or limited by the type and structure of the filter three-way valve 126.

For example, the filter three-way valve 126 may include a first port (not illustrated) into which the reaction fluid supplied to the reaction fluid supply line 110 is introduced, a second port (not illustrated) connected to the first filter line 122 and configured to guide the reaction fluid, which has passed through the first port, to the first filter line 122, and a third port (not illustrated) connected to the second filter line 124 and configured to guide the reaction fluid, which has passed through the first port, to the second filter line 124. The filter three-way valve 126 may selectively switch the movement route for the reaction fluid by opening or closing the first to third ports.

The operation of opening or closing the first to third ports can be defined as including both an operation of completely closing or opening the first to third ports and an operation of adjusting an opening degree (valve opening angle) (e.g., adjusting a degree to which the port is opened).

According to an example embodiment of the present disclosure, the electrochemical system 10 may include a first filter ion sensor 122b positioned at a downstream side of the first filter 122a, provided in the first filter line 122, and configured to sense ionic conductivity of the reaction fluid, and a second filter ion sensor 124b positioned at a downstream side of the second filter 124a, provided in the second filter line 124, and configured to sense ionic conductivity of the reaction fluid.

Various ion sensors capable of sensing the ionic conductivity of the reaction fluid may be used as the first filter ion sensor 122b and the second filter ion sensor 124b. The present disclosure is not necessarily restricted or limited by the types and structures of the first filter ion sensor 122b and the second filter ion sensor 124b.

In particular, the movement route for the reaction fluid may be controlled by controlling the filter three-way valve 126 on the basis of sensing results from the first filter ion sensor 122b and the second filter ion sensor 124b.

The filter three-way valve 126 may be configured to switch the movement route for the reaction fluid, which is supplied along the supply line, to the first filter line 122 or the second filter line 124 on the basis of the sensing results from the first filter ion sensor 122b and the second filter ion sensor 124b.

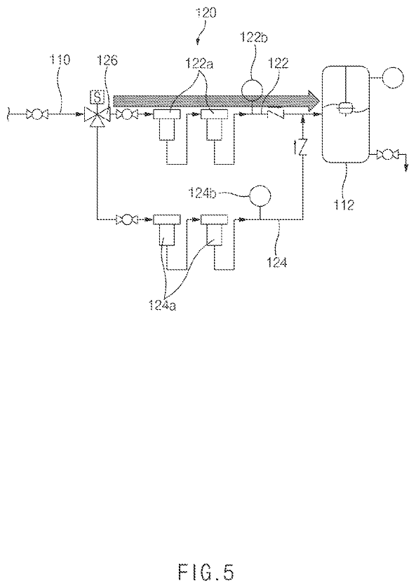

For example, with reference to FIG. 5, in case that the ionic conductivity of the reaction fluid sensed by the second filter ion sensor 124b is higher than a threshold or preset reference ionic conductivity (e.g., 1 μS/cm), the movement route for the reaction fluid, which is supplied along the supply line, may be defined along the first filter line 122 by controlling the filter three-way valve 126.

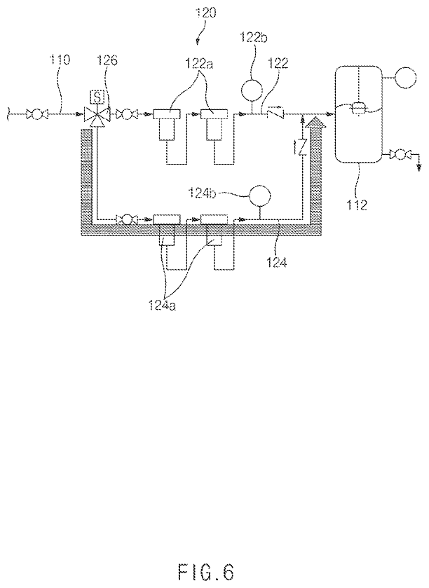

In contrast, as illustrated in FIG. 6, in case that the ionic conductivity of the reaction fluid sensed by the first filter ion sensor 122b is higher than the threshold or preset reference ionic conductivity (e.g., 1 μS/cm), the movement route for the reaction fluid, which is supplied along the supply line, may be defined as along the second filter line 124 instead of the first filter line 122 by controlling the filter three-way valve 126.

For reference, when the second filter reaches end of life or otherwise needs repair or replacement, the second filter 124a mounted in the second filter line 124 may be replaced with a new filter while the reaction fluid moves along the first filter line 122. In the same way, when the first filter reaches end of life or otherwise needs repair or replacement, the first filter 122a mounted in the first filter line 122 may be replaced with a new filter while the reaction fluid moves along the second filter line 124.

As described above, in an embodiment of the present disclosure, the movement route for the reaction fluid, which is supplied along the supply line, can be selectively switched to the first filter line 122 or the second filter line 124. Therefore, it is possible to obtain an advantageous effect of continuously supplying the reaction fluid to the water electrolysis stack 20 without stopping the operation of the system at the time of replacing a filter. Furthermore, it is possible to obtain an advantageous effect of preventing a low-quality reaction fluid from being supplied to the water electrolysis stack 20.

In particular, when the replacement timing for the first filter 122a or the second filter 124a is reached, an alarm generation part (not illustrated) may generate a visual alarm signal (e.g., a notification window on a control program screen) or an auditory alarm signal to allow an operator to recognize an end-of-life situation of the first filter 122a or the second filter 124a and thus allow the operator to replace the first filter 122a or the second filter 124a, which is at the end of life, in a timely manner.

In the embodiment of the present disclosure illustrated and described above, the example has been described in which the first filter line 122 and the second filter line 124 are connected in parallel on the reaction fluid supply line 110. However, according to another embodiment of the present disclosure, the first filter line and the second filter line may be connected (configured) in series on the reaction fluid supply line.

The first gas-liquid separator 130 can be connected to the reaction fluid supply line 110 and configured to separate the reaction fluid into a gaseous reaction fluid (e.g., oxygen) and a liquid reaction fluid (e.g., water).

Various separation devices capable of separating the reaction fluid into the gaseous reaction fluid and the liquid reaction fluid may be used as the first gas-liquid separator 130. The present disclosure is not necessarily restricted or limited by the type and structure of the first gas-liquid separator 130.

For example, the first gas-liquid separator 130 may be provided in the form of a hollow tank. For example, the reaction fluid supply line 110 may be connected to an approximately central portion of the first gas-liquid separator 130. A drain port (not illustrated) may be provided at an approximately lower end of the first gas-liquid separator 130 and configured to discharge the liquid reaction fluid in the first gas-liquid separator 130 to the outside. In addition, a level sensor (not illustrated) may be provided in the first gas-liquid separator 130 and configured to detect a level of the liquid reaction fluid.

The circulation line 140 may be connected to the first gas-liquid separator 130 via the water electrolysis stack 20, and the liquid reaction fluid separated by the first gas-liquid separator 130 may circulate along the circulation line 140.

More specifically, the reaction fluid (the gaseous reaction fluid and the liquid reaction fluid) discharged from the water electrolysis stack 20 may be supplied or returned to the first gas-liquid separator 130 along the circulation line 140, and the liquid reaction fluid separated by the first gas-liquid separator 130 may be supplied back to the water electrolysis stack 20 along the circulation line 140.

The circulation line 140 may have various structures capable of being connected to the first gas-liquid separator 130 via the water electrolysis stack 20. The present disclosure is not necessarily restricted or limited by the structure and shape of the circulation line 140.

Hereinafter, an example will be described in which the circulation line 140 is connected to a lateral side of the first gas-liquid separator 130 (see FIG. 1). For example, an inlet end of the circulation line 140 may be connected to a lateral side of a lower end of the first gas-liquid separator 130, and an outlet end of the circulation line 140 may be connected to a lateral side of an upper end of the first gas-liquid separator 130.

In particular, the inlet end of the circulation line 140 may be connected to the first gas-liquid separator 130 so that the inlet end of the circulation line 140 is at a position (e.g., a lateral side of a lowermost end of the first gas-liquid separator) lower than a level of the liquid reaction fluid separated by the first gas-liquid separator 130.

In addition, a pump (not illustrated) may be provided in the circulation line 140 and configured to forcibly move the liquid reaction fluid to the water electrolysis stack 20 along the circulation line 140.

According to another embodiment of the present disclosure, the circulation line may be connected to an upper end or other portions of the first gas-liquid separator.

According to the example embodiment of the present disclosure, the electrochemical system 10 may include a storage part 112 positioned at an upstream side of the first gas-liquid separator 130, provided in the reaction fluid supply line 110, and configured to store the reaction fluid.

For example, the storage part 112 may be positioned between the filter part 120 and the first gas-liquid separator 130 and provided in the reaction fluid supply line 110.

The storage part 112 may have various structures capable of storing the reaction fluid. The present disclosure is not necessarily restricted or limited by the structure and shape of the storage part 112.

For example, the storage part 112 may be provided in the form of a hollow tank. The reaction fluid, which has passed through the filter part 120, may be temporarily stored in the storage part 112 before the reaction fluid is supplied to the first gas-liquid separator 130.

In addition, a drain port (not illustrated) may be provided at an approximately lower end of the storage part 112 and configured to selectively discharge the reaction fluid in the storage part 112 to the outside.

The water electrolysis stack 20 may be provided in the circulation line 140 and produce hydrogen and oxygen by decomposing the water (reaction fluid) through an electrochemical reaction.

The water electrolysis stack 20 may have various structures capable of producing hydrogen and oxygen by decomposing the reaction fluid through the electrochemical reaction. The present disclosure is not necessarily restricted or limited by the type and structure of the water electrolysis stack 20.

For example, the water electrolysis stack 20 may be made by stacking a plurality of unit cells (not illustrated) in a preset reference stacking direction.

More specifically, the unit cell may include a reaction layer (not illustrated), and separators (not illustrated) respectively stacked on two opposite surfaces of the reaction layer. The water electrolysis stack 20 may be configured by stacking the plurality of unit cells in the reference stacking direction and then fastening endplates (not illustrated) to two opposite ends of the stack of the plurality of unit cells.

The reaction layer may have various structures capable of generating the electrochemical reaction of the reaction fluid (e.g., water). The present disclosure is not necessarily restricted or limited by the type and structure of the reaction layer.

For example, the reaction layer may include a membrane electrode assembly (MEA) (not illustrated), a first porous transport layer (not illustrated) in close contact with one surface of the membrane electrode assembly, and a second porous transport layer (not illustrated) in close contact with the other surface of the membrane electrode assembly.

The membrane electrode assembly may be variously changed in structure and material in accordance with required conditions and design specifications. The present disclosure is not necessarily restricted or limited by the structure and material of the membrane electrode assembly.

For example, the membrane electrode assembly may be configured by attaching catalyst electrode layers (e.g., an anode electrode layer and a cathode electrode layer), in which electrochemical reactions are generated, to two opposite surfaces of an electrolyte membrane.

The first and second porous transport layers may uniformly distribute the reaction fluid and each have a porous structure having pores with set or predetermined sizes.

For reference, water supplied to the anode electrode layer, which is an oxidation electrode for the water electrolysis, may be separated into hydrogen ions (protons), electrons, and oxygen. The hydrogen ions move to the cathode electrode layer, which is a reduction electrode, through the electrolyte membrane, and the electrons may move to a cathode through an external circuit. In addition, the oxygen may be discharged through an anode outlet, and the hydrogen ions and the electrons may be converted into hydrogen at the cathode.

The first bypass line 150 may be configured to allow the liquid reaction fluid, which is separated by the first gas-liquid separator 130, to selectively flow to the downstream side of the water electrolysis stack 20 without passing through the water electrolysis stack 20.

More specifically, one end of the first bypass line 150 may be positioned at the upstream side of the water electrolysis stack 20 (e.g., between the first gas-liquid separator and an inlet of the water electrolysis stack) and connected to the circulation line 140, and the other end of the first bypass line 150 may be positioned at the downstream side of the water electrolysis stack 20 (e.g., between an outlet of water electrolysis stack and the first gas-liquid separator) and connected to the circulation line 140.

The first bypass line 150 may have various structures in accordance with required conditions and design specifications. The present disclosure is not necessarily restricted or limited by the structure and shape of the first bypass line 150. For example, the first bypass line 150 may have an approximately straight shape. According to another embodiment of the present disclosure, the first bypass line may have a curved shape or other shapes.

According to an example embodiment of the present disclosure, the electrochemical system 10 may include a first circulation three-way valve 142a provided in the circulation line 140 and connected to one end of the first bypass line 150.

Various three-way valves capable of allowing the liquid reaction fluid, which is supplied from the first gas-liquid separator 130 to the water electrolysis stack 20 along the circulation line 140, to selectively flow to the downstream side of the water electrolysis stack 20 may be used as the first circulation three-way valve 142a. The present disclosure is not necessarily restricted or limited by the type and structure of the first circulation three-way valve 142a.

For example, the first circulation three-way valve 142a may have a structure identical or similar to the above-mentioned structure of the filter three-way valve 126.

According to an example embodiment of the present disclosure, the electrochemical system 10 may include a first circulation ion sensor 142b positioned at the upstream side of the water electrolysis stack 20, provided in the circulation line 140, and configured to sense the ionic conductivity of the liquid reaction fluid.

Various ion sensors capable of sensing the ionic conductivity of the liquid reaction fluid may be used as the first circulation ion sensor 142b. The present disclosure is not necessarily restricted or limited by the type and structure of the first circulation ion sensor 142b.

In particular, the movement route for the liquid reaction fluid may be controlled by controlling the first circulation three-way valve 142a on the basis of a sensing result from the first circulation ion sensor 142b.

The first circulation three-way valve 142a may be configured to allow the liquid reaction fluid to selectively flow from the upstream side of the water electrolysis stack 20 to the downstream side of the water electrolysis stack 20 on the basis of the sensing result from the first circulation ion sensor 142b.

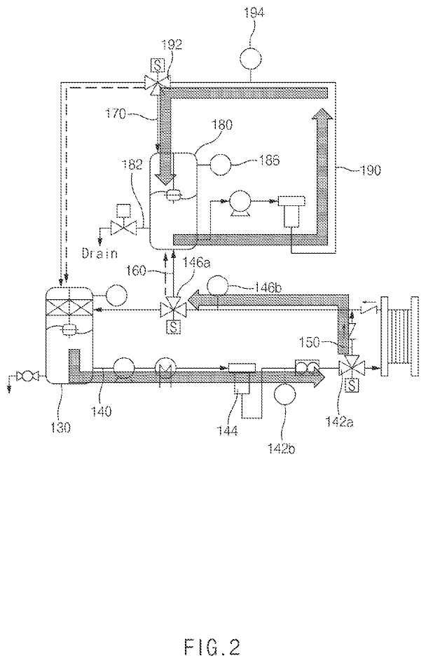

For example, with reference to FIG. 2, in case that the ionic conductivity of the liquid reaction fluid sensed by the first circulation ion sensor 142b is higher than the preset reference ionic conductivity (e.g., 1 μS/cm), the first circulation three-way valve 142a may be controlled such that the liquid reaction fluid separated by the first gas-liquid separator 130 may flow to the downstream side of the water electrolysis stack 20 along the first bypass line 150 without passing through the water electrolysis stack 20.

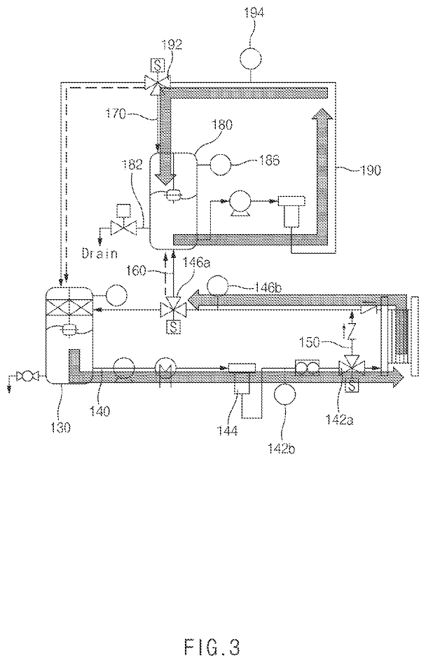

In contrast, as illustrated in FIG. 3, in case that the ionic conductivity of the liquid reaction fluid sensed by the first circulation ion sensor 142b is equal to or lower than the preset reference ionic conductivity (e.g., 1 μS/cm), the first circulation three-way valve 142a may be controlled such that the liquid reaction fluid separated by the first gas-liquid separator 130 is supplied to the water electrolysis stack 20 instead of the first bypass line 150, and the liquid reaction fluid may be used as water to be supplied to the water electrolysis stack 20.

As described above, in an embodiment of the present disclosure, the liquid reaction fluid separated by the first gas-liquid separator 130 selectively flows to the downstream side of the water electrolysis stack 20 without passing through the water electrolysis stack 20. Therefore, by using an embodiment of the present disclosure, it is possible to obtain an advantageous effect of ensuring the quality of the reaction fluid to be supplied to the water electrolysis stack 20, improving the reusability of the reaction fluid, and improving the durability and stability.

The performance, durability, and stability of the water electrolysis stack 20 may deteriorate when a low-quality reaction fluid (e.g., a liquid reaction fluid having high ionic conductivity) is supplied to the water electrolysis stack 20. In an embodiment of the present disclosure, in case that the ionic conductivity of the liquid reaction fluid separated by the first gas-liquid separator 130 is higher than the reference ionic conductivity (e.g., 1 μS/cm), the liquid reaction fluid flows to the downstream side of the water electrolysis stack 20 along the bypass line without being supplied to the water electrolysis stack 20, and then the liquid reaction fluid is reprocessed (e.g., deionized). Therefore, using an embodiment of the present disclosure, it is possible to obtain an advantageous effect of ensuring the quality of the reaction fluid to be supplied to the water electrolysis stack 20, improving the reusability of the reaction fluid, and improving the durability and stability.

Among other things, according to an embodiment of the present disclosure, it is possible to obtain an advantageous effect of extending the lifespan of the water electrolysis stack 20 and minimizing the deterioration in durability and stability of the water electrolysis stack 20 caused when the low-quality reaction fluid is supplied to the water electrolysis stack 20.

According to an example embodiment of the present disclosure, the electrochemical system 10 may include a circulation filter 144 positioned between the first gas-liquid separator 130 and the inlet of the water electrolysis stack 20, provided in the circulation line 140, and configured to filter the liquid reaction fluid.

Various ion filters capable of filtering out ions and foreign substances (impurities) contained in the liquid reaction fluid may be used as the circulation filter 144. The present disclosure is not necessarily restricted or limited by the type and properties of the ion filter. For example, ion exchange resin or the like may be used for the circulation filter 144.

As described above, in an embodiment of the present disclosure, the liquid reaction fluid, which recirculates along the first bypass line 150, may be filtered once again by the circulation filter 144 before being supplied to the water electrolysis stack 20. Therefore, using an embodiment of the present disclosure, it is possible to obtain an advantageous effect of further improving the quality of the reaction fluid to be supplied to the water electrolysis stack 20 and further improving the durability and stability of the water electrolysis stack 20.

According to an example embodiment of the present disclosure, the electrochemical system 10 may include a second bypass line 160 positioned at the downstream side of the water electrolysis stack 20 and connected to the circulation line 140, a second gas-liquid separator 180 connected to the second bypass line 160 and configured to separate the liquid reaction fluid, which flows along the second bypass line 160, into the gaseous reaction fluid and the liquid reaction fluid, and a recirculation line 190 having one end connected to the second gas-liquid separator 180, and the other end connected to the first gas-liquid separator 130, the recirculation line 190 being configured to recirculate the liquid reaction fluid, which has passed through the second gas-liquid separator 180, to the first gas-liquid separator 130.

The second bypass line 160 is configured to allow the liquid reaction fluid, which has passed through the water electrolysis stack 20 or the first bypass line 150, to selectively flow to the second gas-liquid separator 180 without circulating directly to the first gas-liquid separator 130.

More specifically, one end of the second bypass line 160 may be positioned at the downstream side of the water electrolysis stack 20 (e.g., between the outlet of the water electrolysis stack and the first gas-liquid separator) and connected to the circulation line 140, and the other end of the second bypass line 160 may be connected to the second gas-liquid separator 180 (e.g., a lower end of the second gas-liquid separator).

The second bypass line 160 may have various structures in accordance with required conditions and design specifications. The present disclosure is not necessarily restricted or limited by the structure and shape of the second bypass line 160. For example, the second bypass line 160 may have an approximately straight shape. According to another embodiment of the present disclosure, the second bypass line may have a curved shape or other shapes.

The second gas-liquid separator 180 may be connected to the circulation line 140 and configured to separate the liquid reaction fluid, which has passed through the water electrolysis stack 20 or the first bypass line 150, into the gaseous reaction fluid and the liquid reaction fluid once again.

Various separation devices capable of separating the liquid reaction fluid into the gaseous reaction fluid and the liquid reaction fluid may be used as the second gas-liquid separator 180. The present disclosure is not necessarily restricted or limited by the type and structure of the second gas-liquid separator 180.

For example, the second gas-liquid separator 180 may be provided in the form of a hollow tank. For example, the second bypass line 160 may be connected to the lower end of the second gas-liquid separator 180, and the recirculation line 190 may be connected to the approximately central portion of the second gas-liquid separator 180. In addition, a level sensor (not illustrated) may be provided in the second gas-liquid separator 180 and configured to detect a level of the liquid reaction fluid.

The recirculation line 190 may be configured to recirculate the liquid reaction fluid, which is made by the gas-liquid separation performed by the second gas-liquid separator 180, to the first gas-liquid separator 130.

More specifically, one end of the recirculation line 190 may be connected to the second gas-liquid separator 180, the other end of the recirculation line 190 may be connected to the first gas-liquid separator 130, and the liquid reaction fluid, which has passed through the second gas-liquid separator 180, may recirculate to the first gas-liquid separator 130 along the recirculation line 190.

The recirculation line 190 may have various structures capable of connecting the second gas-liquid separator 180 and the first gas-liquid separator 130. The present disclosure is not necessarily restricted or limited by the structure and shape of the recirculation line 190.

For example, an inlet end of the recirculation line 190 may be connected to a lateral side of a lower end of the second gas-liquid separator 180, and an outlet end of the recirculation line 190 may be connected to an upper end of the first gas-liquid separator 130.

In particular, the inlet end of the recirculation line 190 may be connected to the second gas-liquid separator 180 so that the inlet end of the recirculation line 190 is positioned at a position lower than a level of the liquid reaction fluid separated by the second gas-liquid separator 180.

In addition, the recirculation line 190 may be equipped with various types of accessory devices, such as a pump (not illustrated) configured to forcibly move the liquid reaction fluid along the recirculation line 190, and a filter configured to filter the liquid reaction fluid. The present disclosure is not necessarily restricted or limited by the types of accessory devices and the number of accessory devices.

According to an example embodiment of the present disclosure, the electrochemical system 10 may include a second circulation three-way valve 146a provided in the circulation line 140 and connected to one end of the second bypass line 160.

Various three-way valves capable of allowing the liquid reaction fluid, which has passed through the water electrolysis stack 20 or the first bypass line 150, to selectively flow to the second gas-liquid separator 180 along the second bypass line 160 may be used as the second circulation three-way valve 146a. The present disclosure is not necessarily restricted or limited by the type and structure of the second circulation three-way valve 146a.

For example, the second circulation three-way valve 146a may have a structure identical or similar to the above-mentioned structure of the filter three-way valve 126.

According to an example embodiment of the present disclosure, the electrochemical system 10 may include a second circulation ion sensor 146b positioned at the downstream side of the water electrolysis stack 20, provided in the circulation line 140, and configured to sense the ionic conductivity of the liquid reaction fluid.

Various ion sensors capable of sensing the ionic conductivity of the liquid reaction fluid may be used as the second circulation ion sensor 146b. The present disclosure is not necessarily restricted or limited by the type and structure of the second circulation ion sensor 146b.

In particular, the movement route for the liquid reaction fluid may be controlled by controlling the second circulation three-way valve 146a on the basis of a sensing result from the second circulation ion sensor 146b.

The second circulation three-way valve 146a may be configured to allow the liquid reaction fluid to selectively flow from the circulation line 140 to the second bypass line 160 on the basis of the sensing result from the second circulation ion sensor 146b.

For example, with reference to FIGS. 2 and 3, in case that the ionic conductivity of the liquid reaction fluid sensed by the second circulation ion sensor 146b is higher than the preset reference ionic conductivity (e.g., 1 μS/cm), the second circulation three-way valve 146a may be controlled such that the liquid reaction fluid, which has passed through the water electrolysis stack 20 or the first bypass line 150, may flow to the second gas-liquid separator 180 along the second bypass line 160 without circulating directly to the first gas-liquid separator 130.

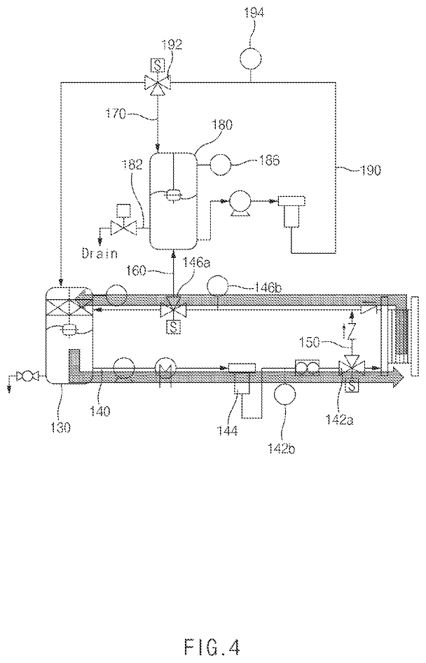

In contrast, as illustrated in FIG. 4, in case that the ionic conductivity of the liquid reaction fluid sensed by the second circulation ion sensor 146b is equal to or lower than the preset reference ionic conductivity (e.g., 1 μS/cm), the second circulation three-way valve 146a may be controlled such that the liquid reaction fluid, which has passed through the water electrolysis stack 20 or the first bypass line 150, may be supplied to the first gas-liquid separator 130 instead of the second gas-liquid separator 180.

According to an example embodiment of the present disclosure, the electrochemical system 10 may include a third bypass line 170 configured to allow the liquid reaction fluid, which has passed through the second gas-liquid separator 180, to selectively flow back to the second gas-liquid separator 180 without recirculating directly to the first gas-liquid separator 130.

More specifically, one end of the third bypass line 170 may be positioned at the downstream side of the second gas-liquid separator 180 (e.g., between the inlet end of the recirculation line and the first gas-liquid separator) and connected to the recirculation line 190, and the other end of the third bypass line 170 may be connected to the second gas-liquid separator 180 (e.g., an upper end of the second gas-liquid separator).

The third bypass line 170 may have various structures in accordance with required conditions and design specifications. The present disclosure is not necessarily restricted or limited by the structure and shape of the third bypass line 170. For example, the third bypass line 170 may have an approximately straight shape. According to another embodiment of the present disclosure, the third bypass line may have a curved shape or other shapes.

According to an example embodiment of the present disclosure, the electrochemical system 10 may include a recirculation three-way valve 192 provided in the recirculation line 190 and connected to one end of the third bypass line 170.

Various three-way valves capable of allowing the liquid reaction fluid, which is supplied from the second gas-liquid separator 180 to the first gas-liquid separator 130 along the recirculation line 190, to selectively flow back to the second gas-liquid separator 180 may be used as the recirculation three-way valve 192. The present disclosure is not necessarily restricted or limited by the type and structure of the recirculation three-way valve 192.

For example, the recirculation three-way valve 192 may have a structure identical or similar to the above-mentioned structure of the filter three-way valve 126.

According to an example embodiment of the present disclosure, the electrochemical system 10 may include a recirculation ion sensor 194 provided in the recirculation line 190 and configured to sense the ionic conductivity of liquid reaction fluid.

Various ion sensors capable of sensing the ionic conductivity of the liquid reaction fluid may be used as the recirculation ion sensor 194. The present disclosure is not necessarily restricted or limited by the type and structure of the recirculation ion sensor 194.

In particular, the movement route for the liquid reaction fluid may be controlled by controlling the recirculation three-way valve 192 on the basis of a sensing result from the recirculation ion sensor 194.

The recirculation three-way valve 192 may be configured to allow the liquid reaction fluid to selectively flow from the recirculation line 190 to the third bypass line 170 (the second gas-liquid separator) on the basis of the sensing result from the recirculation ion sensor 194.

For example, with reference to FIG. 2, in case that the ionic conductivity of the liquid reaction fluid sensed by the recirculation ion sensor 194 is higher than the preset reference ionic conductivity (e.g., 1 μS/cm), the recirculation three-way valve 192 may be controlled such that the liquid reaction fluid separated by the second gas-liquid separator 180 may flow back to the second gas-liquid separator 180 via the third bypass line 170.

In contrast, in case that the ionic conductivity of the liquid reaction fluid sensed by the recirculation ion sensor 194 is equal to or lower than the preset reference ionic conductivity (e.g., 1 μS/cm), the recirculation three-way valve 192 may be controlled such that the liquid reaction fluid separated by the second gas-liquid separator 180 may be supplied to the first gas-liquid separator 130 instead of the third bypass line 170.

With reference to FIGS. 1 and 7 to 8, according to an example embodiment of the present disclosure, the electrochemical system 10 may include a first cleaning line 114 having one end connected to the storage part 112, and the other end connected to the second gas-liquid separator 180, the first cleaning line 114 being configured to discharge the reaction fluid to an inner wall surface of the second gas-liquid separator 180.

The first cleaning line 114 may be configured to clean the inner wall surface of the second gas-liquid separator 180 by supplying the reaction fluid in the storage part 112 to the inner wall surface of the second gas-liquid separator 180.

The first cleaning line 114 may have various structures capable of supplying the reaction fluid in the storage part 112 to the second gas-liquid separator 180. The present disclosure is not necessarily restricted or limited by the structure and shape of the first cleaning line 114.

According to an example embodiment of the present disclosure, the first cleaning line 114 may include a nozzle 114a capable of spraying the reaction fluid in the storage part 112 to the inner wall surface of the second gas-liquid separator 180.

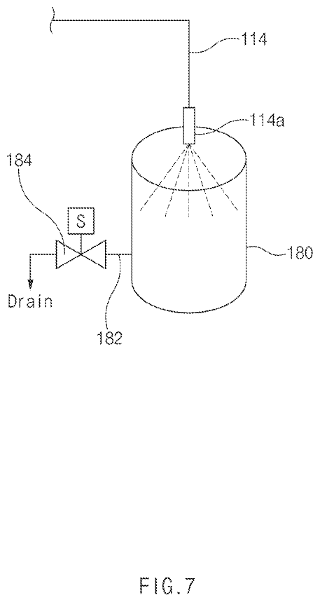

For example, with reference to FIG. 7, the nozzle 114a may be configured to be rotatable (e.g., by 90 to 360 degrees) in the second gas-liquid separator 180. The inner wall surface of the second gas-liquid separator 180 may be cleaned by the reaction fluid sprayed from the nozzle 114a that rotates in the second gas-liquid separator 180.

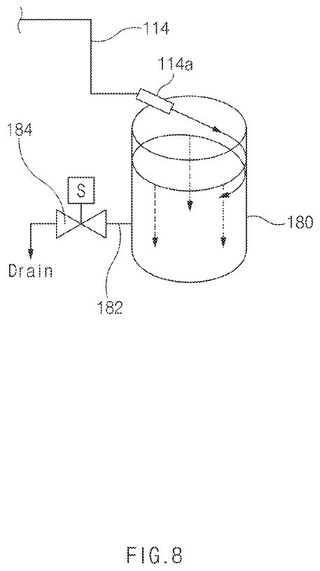

As another example, with reference to FIG. 8, the nozzle 114a may be configured to spray the reaction fluid in a direction inclined with respect to a reference line passing through a center of the second gas-liquid separator 180. The reaction fluid sprayed from the nozzle 114a may clean the inner wall surface of the second gas-liquid separator 180 while flowing downward in a vortex shape along the inner wall surface of the second gas-liquid separator 180. Among other things, in an embodiment of the present disclosure, the reaction fluid sprayed from the nozzle 114a may flow downward in a vortex shape. Therefore, using an embodiment of the present disclosure, it is possible to obtain an advantageous effect of minimizing the amount of use of the reaction fluid used as washing water.

In particular, the nozzle 114a may be made of a stainless material excellent in corrosion resistance. Alternatively, the nozzle 114a may be made of synthetic resin or other materials excellent in corrosion resistance.

According to an example embodiment of the present disclosure, the electrochemical system 10 may include a discharge line 182 connected to the second gas-liquid separator 180 and configured to discharge the liquid reaction fluid to the outside from the second gas-liquid separator 180, an on-off valve 184 configured to selectively open or close the discharge line 182, and an ion sensor 186 provided in the second gas-liquid separator 180 and configured to sense the ionic conductivity of the liquid reaction fluid in the second gas-liquid separator 180. The on-off valve 184 may selectively open the discharge line 182 on the basis of a sensing result from the ion sensor 186.

The discharge line 182 may have various structures capable of discharging the liquid reaction fluid to the outside from the second gas-liquid separator 180. The present disclosure is not necessarily restricted or limited by the structure and shape of the discharge line 182. For example, the discharge line 182 may have an approximately straight shape and be connected to a lower end of the second gas-liquid separator 180.

A typical valve (e.g., a solenoid valve) capable of selectively opening or closing the discharge line 182 may be used as the on-off valve 184. The present disclosure is not necessarily restricted or limited by the type and structure of the on-off valve 184.

Various ion sensors capable of sensing the ionic conductivity of the liquid reaction fluid in the second gas-liquid separator 180 (and similarly also in the storage part 112) may be used as the ion sensor 186. The present disclosure is not restricted or limited by the type and structure of the ion sensor 186.

The opening/closing time point of the discharge line 182 (a time point at which the liquid reaction fluid is discharged from the second gas-liquid separator 180, and similarly for the storage part 112) may be controlled by controlling the on-off valve 184 on the basis of the sensing result from the ion sensor 186.

For example, in case that the ionic conductivity of the liquid reaction fluid sensed by the ion sensor 186 is higher than a preset reference ionic conductivity (e.g., 5 μS/cm), the on-off valve 184 may be controlled to open the discharge line 182, such that the liquid reaction fluid may be discharged to the outside from the second gas-liquid separator 180.

According to an example embodiment of the present disclosure, the first cleaning line 114 may be configured to supply the reaction fluid to the inner wall surface of the second gas-liquid separator 180 for a preset cleaning time (e.g., 3 minutes) in the state in which the discharge line 182 is opened when the liquid reaction fluid is discharged along the discharge line 182 for a preset discharge time (e.g., 10 minutes).

As described above, in an embodiment of the present disclosure, the reaction fluid stored in the storage part 112 may be used as washing water and sprayed to the inner wall surface of the second gas-liquid separator 180, thereby removing contaminants remaining on the inner wall surface of the second gas-liquid separator 180. Therefore, using an embodiment of the present disclosure, it is possible to obtain an advantageous effect of minimizing the deterioration in characteristics of the liquid reaction fluid (e.g., contamination) caused by contaminants remaining on the inner wall surface of the second gas-liquid separator 180, and preventing a low-quality liquid reaction fluid containing contaminants from being supplied to the water electrolysis stack 20.

Moreover, in an embodiment of the present disclosure, in case that the ionic conductivity of the liquid reaction fluid in the second gas-liquid separator 180 is higher than the preset reference ionic conductivity, the liquid reaction fluid may be discharged to the outside through the discharge line 182 in an intact manner. Therefore, using an embodiment of the present disclosure, it is possible to obtain an advantageous effect of minimizing the number of components and processes required to reprocess (reproduce) the liquid reaction fluid.

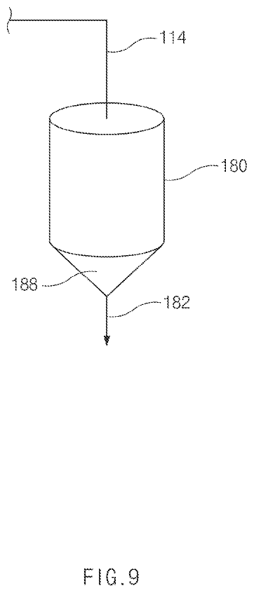

With reference to FIG. 9, according to an example embodiment of the present disclosure, the electrochemical system 10 may include an outlet port 188 connected to the discharge line 182 and provided at a lower end of the second gas-liquid separator 180 based on the gravitational direction. The outlet port 188 may have a cross-sectional area that gradually decreases downward from the upper side thereof.

For example, the outlet port 188 may have an approximately conical shape having a cross-sectional area that gradually decreases downward from the upper side thereof.

As described above, in an embodiment of the present disclosure, the outlet port 188 may have a cross-sectional area that gradually decreases downward from the upper side thereof. Therefore, using an embodiment of the present disclosure, it is possible to obtain an advantageous effect of ensuring the smooth discharge of the contaminants and the liquid reaction fluid through the discharge line 182 and preventing the contaminants from remaining on a bottom portion of the second gas-liquid separator 180.

With reference to FIG. 1, according to an example embodiment of the present disclosure, the electrochemical system 10 may include a second cleaning line 116 having one end connected to (branching off from) the first cleaning line 114, and the other end connected to the first gas-liquid separator 130, the second cleaning line 116 may be configured to supply the reaction fluid to an inner wall surface of the first gas-liquid separator 130.

The second cleaning line 116 may have various structures capable of supplying the reaction fluid in the storage part 112 to the first gas-liquid separator 130. The present disclosure is not necessarily restricted or limited by the structure and shape of the second cleaning line 116.

According to an example embodiment of the present disclosure, the second cleaning line 116 may be configured to spray the reaction fluid from the storage part 112 to the inner wall surface of the first gas-liquid separator 130 in the same or similar way as the first cleaning line 114.

According to an embodiment of the present disclosure described above, it is possible to obtain an advantageous effect of ensuring the performance of the water electrolysis stack and improving the durability and stability of the water electrolysis stack.

In particular, according to an embodiment of the present disclosure, the low-quality reaction fluid (e.g., the reaction fluid having high ionic conductivity) may flow to the circulation line along the bypass line without being supplied to the water electrolysis stack, and then the low-quality reaction fluid may be reprocessed (e.g., deionized). Therefore, using an embodiment of the present disclosure, it is possible to obtain an advantageous effect of ensuring the quality of the reaction fluid to be supplied to the water electrolysis stack, improving the reusability of the reaction fluid, and improving the durability and stability.

Among other things, according to an embodiment of the present disclosure, it is possible to obtain an advantageous effect of extending the lifespan of the water electrolysis stack and minimizing the deterioration in durability and stability of the water electrolysis stack caused when the low-quality reaction fluid is supplied to the water electrolysis stack.

In addition, according to the embodiment of the present disclosure, it is possible to obtain an advantageous effect of continuously supplying the reaction fluid to the water electrolysis stack without stopping the operation of the system at the time of replacing the filter, and preventing the low-quality reaction fluid from being supplied to the water electrolysis stack.

In addition, according to an embodiment of the present disclosure, it is possible to obtain an advantageous effect of preventing contaminants, which remain on the inner wall surface of the gas-liquid separator, from being supplied to the water electrolysis stack.

While embodiments have been described above, the embodiments are just illustrative and not intended to necessarily limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, differences related to the modifications and applications may be included in the scope of the present disclosure defined by the appended claims.

What is claimed is:

1. An electrochemical system comprising:
a reaction fluid supply line configured to supply a reaction fluid;
a first gas-liquid separator connected to the reaction fluid supply line and configured to separate the reaction fluid into a gaseous reaction fluid and a liquid reaction fluid;
a circulation line connected to the first gas-liquid separator and configured to allow the liquid reaction fluid to circulate therethrough;
a water electrolysis stack provided in the circulation line; and
a first bypass line having a first end at an upstream side of the water electrolysis stack and connected to the circulation line, and a second end at a downstream side of the water electrolysis stack and connected to the circulation line.

2. The electrochemical system of claim 1, further comprising a first circulation three-way valve provided in the circulation line and connected to the first end of the first bypass line.

3. The electrochemical system of claim 2, further comprising a first circulation ion sensor at the upstream side of the water electrolysis stack, provided in the circulation line, and configured to sense ionic conductivity of the liquid reaction fluid, wherein the first circulation three-way valve is configured to allow the liquid reaction fluid to selectively flow from the upstream side of the water electrolysis stack to the downstream side of the water electrolysis stack based on a sensing result from the first circulation ion sensor.

4. The electrochemical system of claim 1, further comprising a circulation filter positioned between the first gas-liquid separator and an inlet of the water electrolysis stack, provided in the circulation line, and configured to filter the liquid reaction fluid.

5. An electrochemical system comprising:
a reaction fluid supply line configured to supply a reaction fluid;
a first gas-liquid separator connected to the reaction fluid supply line and configured to separate the reaction fluid into a gaseous reaction fluid and a liquid reaction fluid;
a circulation line connected to the first gas-liquid separator and configured to allow the liquid reaction fluid to circulate therethrough;
a water electrolysis stack provided in the circulation line;
a first bypass line having a first end at an upstream side of the water electrolysis stack and connected to the circulation line, and a second end at a downstream side of the water electrolysis stack and connected to the circulation line; and
a filter part provided in the reaction fluid supply line and configured to filter the reaction fluid.

6. The electrochemical system of claim 5, wherein the filter part comprises:
a first filter line connected to the reaction fluid supply line and equipped with a first filter; and
a second filter line connected in parallel with the first filter line, connected to the reaction fluid supply line, and equipped with a second filter.

7. The electrochemical system of claim 6, further comprising a filter three-way valve provided in the reaction fluid supply line and connected to one end of the first filter line and one end of the second filter line.

8. The electrochemical system of claim 7, further comprising:
a first filter ion sensor at a downstream side of the first filter, provided in the first filter line, and configured to sense ionic conductivity of the reaction fluid; and
a second filter ion sensor at a downstream side of the second filter, provided in the second filter line, and configured to sense ionic conductivity of the reaction fluid, wherein the filter three-way valve is configured to selectively switch a movement route for the reaction fluid to the first filter line or the second filter line based on sensing results from the first filter ion sensor and the second filter ion sensor.

9. An electrochemical system comprising:
a reaction fluid supply line configured to supply a reaction fluid;
a first gas-liquid separator connected to the reaction fluid supply line and configured to separate the reaction fluid into a gaseous reaction fluid and a liquid reaction fluid;
a circulation line connected to the first gas-liquid separator and configured to allow the liquid reaction fluid to circulate therethrough;
a water electrolysis stack provided in the circulation line;
a first bypass line having a first end at an upstream side of the water electrolysis stack and connected to the circulation line, and a second end at a downstream side of the water electrolysis stack and connected to the circulation line;
a second bypass line at the downstream side of the water electrolysis stack and connected to the circulation line;
a second gas-liquid separator connected to the second bypass line and configured to separate the liquid reaction fluid that flows along the second bypass line, into a gaseous reaction fluid and a liquid reaction fluid; and
a recirculation line having a first recirculating end connected to the second gas-liquid separator, and a second recirculating end connected to the first gas-liquid separator, the recirculation line being configured to recirculate the liquid reaction fluid that has passed through the second gas-liquid separator, to the first gas-liquid separator.

10. The electrochemical system of claim 9, further comprising a second circulation three-way valve provided in the circulation line and connected to a first second-bypass end of the second bypass line.

11. The electrochemical system of claim 10, further comprising a second circulation ion sensor at the downstream side of the water electrolysis stack, provided in the circulation line, and configured to sense ionic conductivity of the liquid reaction fluid, wherein the second circulation three-way valve is configured to allow the liquid reaction fluid to selectively flow from the circulation line to the second bypass line based on a sensing result from the second circulation ion sensor.

12. The electrochemical system of claim 9, further comprising a third bypass line having a first third-bypass end connected to the recirculation line, and a second third-bypass end connected to the second gas-liquid separator.

13. The electrochemical system of claim 12, further comprising a recirculation three-way valve provided in the recirculation line and connected to the third bypass line.

14. The electrochemical system of claim 13, comprising a recirculation ion sensor provided in the recirculation line and configured to sense ionic conductivity of the liquid reaction fluid, wherein the recirculation three-way valve is configured to allow the liquid reaction fluid to selectively flow from the recirculation line to the third bypass line based on a sensing result from the recirculation ion sensor.

15. The electrochemical system of claim 9, further comprising a storage part at an upstream side of the first gas-liquid separator, provided in the reaction fluid supply line, and configured to store the reaction fluid.

16. The electrochemical system of claim 15, further comprising a first cleaning line having a first cleaning-line end connected to the storage part, and a second cleaning-line end connected to the second gas-liquid separator, the first cleaning line being configured to supply the reaction fluid to an inner wall surface of the second gas-liquid separator.

17. The electrochemical system of claim 16, further comprising:
a discharge line connected to the second gas-liquid separator and configured to discharge the liquid reaction fluid outside from the second gas-liquid separator;
an on-off valve configured to selectively open or close the discharge line; and
an ion sensor provided in the second gas-liquid separator and configured to sense ionic conductivity of the liquid reaction fluid in the second gas-liquid separator, wherein the on-off valve is configured to selectively open the discharge line based on a sensing result from the ion sensor.

18. The electrochemical system of claim 17, wherein the first cleaning line is configured to supply the reaction fluid to the inner wall surface of the second gas-liquid separator for a preset cleaning time.

19. The electrochemical system of claim 17, further comprising an outlet port connected to the discharge line and provided at a lower end of the second gas-liquid separator based on a gravitational direction, wherein the outlet port has a cross-sectional area that gradually decreases downward from an upper side thereof.

20. The electrochemical system of claim 16, further comprising a second cleaning line having a first second-cleaning-line end connected to the first cleaning line, and a second second-cleaning-line end connected to the first gas-liquid separator, the second cleaning line being configured to supply the reaction fluid to an inner wall surface of the first gas-liquid separator.
